(19) United States
(12) Patent Application Publication
(10) Pub. No.: US 2013/0014705 A1
(43) Pub. Date: Jan. 17, 2013

(54) INTERCHANGEABLE PET HARNESS APPAREL

(71) Applicants: Hyeon I. Cho, Allendale, NJ (US); Wha Ja Ha, Seoul (KR)

(72) Inventors: Hyeon I. Cho, Allendale, NJ (US); Wha Ja Ha, Seoul (KR)

(21) Appl. No.: 13/548,912

(22) Filed: Jul. 13, 2012

Related U.S. Application Data
(60) Provisional application No. 61/507,509, filed on Jul. 13, 2011.

(51) Int. Cl. A01K 13/00; A01K 27/00

(52) U.S. Cl. 119/850; 119/863

(57) ABSTRACT

The interchangeable pet harness apparel wherein the pet owner can mix and match to change the look and style of the pet harness apparel without removing the pet harness or the entire pet apparel. The interchangeable pet harness apparel comprises a pet harness, a plurality of interchangeable bottom parts of the pet apparel, and a plurality of interchangeable top parts of the pet apparel. Each bottom or top part comprises a part connector for removably connecting the respective bottom or top part to the pet harness such that the part connector of the respective bottom or top part mates with the part connector of the pet harness to attach the respective bottom or top part to the pet harness to form a pet harness outfit.

### RELATED APPLICATION

The present application claims the benefit of U.S. Provisional Application No. 61/507,509 filed Jul. 13, 2011, which is incorporated herein by reference in its entirety.

### FIELD OF THE INVENTION

The claimed invention relates to pet harness, and more particularly to interchangeable pet harness apparel.

### BACKGROUND OF INVENTION

Pet owners desire to fashionably dress their pets have led to the evolution of leashes and simple harness into fashionable pet outfits and gears rivaling pet owners apparel. Although we can easily change from one apparel into another, and mix and match tops and bottoms, the pet owners must completely remove one fashionably designed pet harness apparel from the pet and put another pet harness apparel to change the pet outfit. Further, there is no option of mix and matching with currently available pet apparel. The entire pet apparel must be removed from the pet to replace the pet apparel with another.

Although there are several approaches to decorating and personalizing the pet apparel with removable decorative accessories that are attached to the pet apparel, such as U.S. Published Patent Application No. 2010/0277945 to Hurwitz, there is no way for a pet owner to interchange the pet apparel without completely removing the pet apparel from the pet. Hurwitz describes removable accessories, such as jewelry or LEDS, to provide aesthetic appeal and enhance visibility of the pet gear. However, none of these devices address providing interchangeable pet harness apparel, wherein the pet owner can change the look and style of the pet harness apparel without completely removing the pet apparel from the pet.

### SUMMARY OF THE INVENTION

Therefore, it is an object of the claimed invention to provide have interchangeable pet harness apparel wherein the pet owner can just change the pants bottom with a different pants bottom or a skirt bottom to change the look and style of the pet harness apparel without removing the entire pet apparel.

In accordance with an exemplary embodiment of the claimed invention, the interchangeable pet harness apparel comprises a pet harness and a plurality of interchangeable bottom parts of the interchangeable pet apparel. The pet harness comprises at least one D-ring fixedly attached to the pet harness to attach a lease and a part connector at a bottom end of the pet harness. Each bottom part comprises a part connector to removably attach the respective bottom part to the pet harness such that the part connector of the respective bottom part mates with the part connector at the bottom end of the pet harness to attach the respective bottom part to the pet harness to form a pet harness outfit. The part connectors of the pet harness and of the respective bottom part permit the pet harness outfit to be changed without removing the entire pet harness outfit and without removing the pet harness worn by a pet during an attire change by detaching the respective bottom part from the pet harness and replacing it with another bottom part. Preferably, the bottom part of the interchangeable pet harness apparel is pants, shorts, a skirt, panties, pet sanitary panties, a manner band and the like.

In accordance with an exemplary embodiment of the claimed invention, bottom part is pants and the part connector of the pants mates with the part connector at the bottom end of the pet harness to form a pet harness jumpsuit.

In accordance with an exemplary embodiment of the claimed invention, the bottom part of the aforesaid pet harness jumpsuit is interchangeable with another bottom part by decoupling the part connector of the pants from the part connector at the bottom end of the pet harness and mating the part connector of another bottom part, such as a skirt, shorts, panties, pet sanitary panties, a manner band and the like to the part connector at the bottom end of the pet harness to convert the pet harness jumpsuit to a different pet harness outfit, such as a pet harness dress, pet harness shorts, a pet harness with panties, a pet manner harness, etc.

In accordance with an exemplary embodiment of the claimed invention, the color or style of the aforesaid pet harness jumpsuit can be changed by decoupling the part connector of the pants (e.g., a floral pattern pants) from the part connector at the bottom end of the pet harness and mating the part connector of the another pants (e.g., stripe pants) to the part connector at the bottom end of the pet harness.

In accordance with an exemplary embodiment of the claimed invention, the bottom part is a skirt and the part connector of the skirt mates with the part connector at the bottom end of the pet harness to form a pet harness dress.

In accordance with an exemplary embodiment of the claimed invention, the bottom part of the aforesaid pet harness dress is interchangeable with another bottom part by decoupling the part connector of the skirt from the part connector at the bottom end of the pet harness and mating the part connector of another bottom part, such as pants, shorts, panties, pet sanitary panties, a manner band and the like, to the part connector at the bottom end of the pet harness to convert the pet harness dress to a different pet harness outfit, such as a pet harness jumpsuit, pet harness shorts, a pet manner harness, a pet harness with panties, etc.

In accordance with an exemplary embodiment of the claimed invention, the color or style of the aforesaid pet harness dress can be changed by decoupling the part connector of the skirt (e.g., a yellow colored dress) from the part connector at the bottom end of the pet harness and mating the part connector of the another skirt (e.g., a purple colored dress) to the part connector at the bottom end of the pet harness.

In accordance with an exemplary embodiment of the claimed invention, the aforesaid interchangeable pet harness further comprises a part connector at a top end of the pet harness and a plurality of interchangeable top parts of the interchangeable pet apparel. Each top part comprises a part connector to removably attach the respective top part to the pet harness such that the part connector of the respective top part mates with the part connector at the top end of the pet harness to attach the respective top part to the pet harness to form the pet harness outfit. The part connectors of the pet harness and of the respective top part permit the pet harness outfit to be changed without removing the entire pet harness outfit and without removing the pet harness worn by a pet during an attire change by detaching the respective top part from the pet harness and replacing it with another top part.

In accordance with an exemplary embodiment of the claimed invention, the top part is a hood and the part connector of the hood mates with the part connector at the top end of the pet harness to form a hooded pet harness outfit.

In accordance with an exemplary embodiment of the claimed invention, the top part of the aforesaid hooded pet harness outfit is interchangeable with another top part by decoupling the part connector of the hood from the part connector at the top end of the pet harness and mating the part connector of another top part, such as a collar, a neck guard, a turtleneck collar, a clothing collar (e.g., a dress collar, a dress collar with a bow tie, a shirt color, a shirt collar with a neck tie, a blouse collar, a blouse collar with a ribbon, etc.) and the like (collectively referred to herein as the “collar”), a hat or a cap, to the part connector at the top end of the pet harness to convert the hooded pet harness outfit to a different pet harness outfit, such as a collared pet harness outfit, a collared pet harness outfit with a tie, a pet harness outfit with a cap, etc.

In accordance with an exemplary embodiment of the claimed invention, the color or style of the aforesaid hooded pet harness outfit can be changed by decoupling the part connector of the hood (e.g., a red colored hood) from the part connector at the top end of the pet harness and mating the part connector of another hood (e.g., a blue stripe hood) to the part connector at the top end of the pet harness. Alternatively, the color or style of the hooded pet harness outfit can changed by decoupling the part connector of the bottom part (e.g., a black pants, a black dress, a polka dot panties, a striped manner band, etc.) from the part connector at the bottom end of the pet harness and mating the part connector of another bottom part (e.g., a white polka dot pants, a yellow dress, a blue pet sanitary panties, a sailor motif manner band, etc.) to the part connector at the bottom end of the pet harness.

In accordance with an exemplary embodiment of the claimed invention, the top part is a collar and the part connector of the collar mates with the part connector at the top end of the pet harness to form a collared pet harness outfit.

In accordance with an exemplary embodiment of the claimed invention, the top part of the aforesaid collared pet harness outfit is interchangeable with another top part by decoupling the part connector of the collar from the part connector at the top end of the pet harness and mating the part connector of another top part, such as a collar, a hat or a cap, to the part connector at the top end of the pet harness to convert the hooded pet harness outfit to a different pet harness outfit, such as a collared pet harness outfit, a collared pet harness outfit with a tie, a collared pet harness outfit with a ribbon, a pet harness outfit with a hat, a pet harness outfit with a cap, etc.

In accordance with an exemplary embodiment of the claimed invention, the color or style of the aforesaid collared pet harness outfit can be changed by decoupling the part connector of the collar (e.g., a striped turtleneck collar) from the part connector at the top end of the pet harness and mating the part connector of another collar (e.g., a blue neck guard, a white blouse collar with a red ribbon, a black shirt collar with a red polka dot bow tie, etc.) to the part connector at the top end of the pet harness. Alternatively, the color or style of the collar pet harness outfit can changed by decoupling the part connector of the bottom part (e.g., a black pants, a black dress, a polka dot panties, a striped manner band, etc.) from the part connector at the bottom end of the pet harness and mating the part connector of another bottom part (e.g., a white polka dot pants, a yellow dress, a blue pet sanitary panties, a sailor motif manner band, etc.) to the part connector at the bottom end of the pet harness.

In accordance with an exemplary embodiment of the claimed invention, the interchangeable pet harness apparel as aforesaid is made of sturdy, elastic mesh-like polyester material to provide lightweight, breathable and comfortable pet harness apparel.

In accordance with an exemplary embodiment of the claimed invention, the pet harness apparel as aforesaid is made of sturdy material comprising an outer layer, an inner layer and an internal layer between the outer and inner layers. The internal layer is infused with one or more of the following fragrances: relaxing aroma, therapeutic aroma, cologne, perfumes and flea protection agent.

In accordance with an exemplary embodiment of the claimed invention, the pet harness as aforesaid comprises a pair of mated neck ends and a pair of mated torso ends. The mated neck ends wraps around a neck of a pet to adjust the size of a neck opening. The mated torso ends wraps around a torso of the pet to adjust the size of a torso opening.

In accordance with an exemplary embodiment of the claimed invention, the part connector at the bottom end of the pet harness and the part connector of the respective bottom part and/or top part are a pair of mated fastener, snap, button and loop, button and button hole, zipper or a hook and loop strip or pad.

In accordance with an exemplary embodiment of the claimed invention, the part connector of the pet harness comprises a plurality of thin strips. One end of each strip is attached to the bottom end of the pet harness by a first end of mated fastener. A second end of the mated fastener is attached to other end of each strip. The part connector of the respective bottom part comprises an elastic band at the top end of the respective bottom part with predetermined portions of the elastic band being accessible. Each strip at the top end of the pet harness loops around a corresponding accessible portion of the elastic band on the respective bottom part. The second end of the mated fastener on each strip removably connects to the first end of the mated fastener on the each corresponding strip to securely attach the respective bottom part to the pet harness to form a pet harness apparel.

In accordance with an exemplary embodiment of the claimed invention, the interchangeable pet harness apparel comprises a pet harness and a plurality of interchangeable top parts of the interchangeable pet apparel. The pet harness comprises at least one D-ring fixedly attached to the pet harness to attach a lease and a part connector at a top end of the pet harness. Each top part comprises a part connector to removably attach the respective top part to the pet harness such that the part connector of the respective top part mates with the part connector at the top end of the pet harness to attach the respective top part to the pet harness to form a pet harness outfit. The part connectors of the pet harness and of the respective top part permit the pet harness outfit to be changed without removing the entire pet harness outfit and without removing the pet harness worn by a pet during an attire change by detaching the respective top part from the pet harness and replacing it with another top part. Preferably, the top part of the interchangeable pet harness apparel is a collar, a neck guard, a turtleneck collar, a clothing collar, e.g., a dress collar, a dress collar with a bow tie, a shirt color, a shirt collar with a neck tie, a blouse collar, a blouse collar with a ribbon, etc., and the like (collectively referred to herein as the “collar”), a hood, a cap and the like.

In accordance with an exemplary embodiment of the claimed invention, the top part of the interchangeable pet harness apparel is a hood, a cap or a collar to respectively form a hooded pet harness outfit, a pet harness outfit with a cap or a collared pet harness outfit.

In accordance with an exemplary embodiment of the claimed invention, the aforesaid interchangeable pet harness apparel further comprises a plurality of interchangeable bottom parts of the pet apparel. Each bottom part comprising a part connector to removably attach the respective bottom part to the pet harness such that the part connector of the respective bottom part mates with the part connector at a bottom end of the pet harness to attach the respective bottom part to the pet harness. The part connectors at the bottom end of the pet harness and of the respective bottom part permit the respective bottom part to be detached from the pet harness and replaced with another bottom part to change the pet harness outfit without removing the entire pet harness outfit or the pet harness worn by the pet during an attire change.

In accordance with an exemplary embodiment of the claimed invention, the bottom part of the aforesaid interchangeable pet harness apparel is pants or a skirt to form a hooded pet harness outfit (e.g., a hooded pet harness jumpsuit, a hooded pet harness dress, hooded pet harness shorts, a hooded pet manner harness, a hooded pet harness with panties, a hooded pet harness with pet sanitary panties), a pet harness with a cap (e.g., a pet harness jumpsuit with a cap, a pet harness dress with a cap, pet harness shorts with a cap, a pet manner harness with a cap, a pet harness with a cap and panties, a pet harness with a cap and pet sanitary panties), a pet harness with a hat (e.g., a pet harness jumpsuit with a hat, a pet harness dress with a hat, pet harness shorts with a hat, a pet manner harness with a hat, a pet harness with a hat and panties, a pet harness with a hat and pet sanitary panties), or pet collared pet harness outfit (e.g., a pet collared harness jumpsuit, a pet collared harness dress, pet collared harness shorts, a pet collared manner harness, a pet collared harness with panties, a pet collared harness with pet sanitary panties).

Various other objects, advantages and features of the claimed invention will become readily apparent from the ensuing detailed description, and the novel features will be particularly pointed out in the appended claims.

### BRIEF DESCRIPTION OF THE DRAWINGS

These and other advantages of the claimed invention will be described in detail with reference to the following drawings in which like reference numbers refer to like elements:

FIG. 1 is a schematic view of the interchangeable pet harness jumpsuit in accordance with an exemplary embodiment of the claimed invention fitted on a pet;

FIGS. 2A-2B are front and back perspective views of the interchangeable pet harness jumpsuit with the mated neck ends and mated torso ends in accordance with an exemplary embodiment of the claimed invention;

FIG. 3A is a schematic view of the interchangeable pet harness hoodie or hooded top in accordance with an exemplary embodiment of the claimed invention;

FIG. 3B is a side perspective view of the interchangeable hooded pet harness jumpsuit in accordance with an exemplary embodiment of the claimed invention;

FIG. 3C is an exploded view of the part connector of the top part and the part connector at the top end of the pet harness in accordance with an exemplary embodiment of the claimed invention;

FIGS. 4A-4B are front and back perspective views of the interchangeable pet harness jumpsuit with open neck ends and open torso ends in accordance with an exemplary embodiment of the claimed invention;

FIGS. 5A-5B are front and back perspective views of the pet harness and pants (bottom part) of the interchangeable pet harness jumpsuit in an unattached state in accordance with an exemplary embodiment of the claimed invention;

FIG. 5C is an exploded view of the part connector of the pet harness and the part connector of the bottom part (pants) in accordance with an exemplary embodiment of the claimed invention

FIG. 6 is a schematic view of the interchangeable pet harness dress in accordance with an exemplary embodiment of the claimed invention fitted on a pet;

FIGS. 7A-7B are front and back perspective views of the interchangeable pet harness dress with the mated neck ends and mated torso ends in accordance with an exemplary embodiment of the claimed invention;

FIG. 8A is a schematic views of the interchangeable pet harness hoodie or hooded top in accordance with an exemplary embodiment of the claimed invention;

FIG. 8B is a side perspective view of the interchangeable hooded pet harness dress in accordance with an exemplary embodiment of the claimed invention;

FIG. 8C is an exploded view of the part connector of the top part and the part connector at the top end of the pet harness in accordance with an exemplary embodiment of the claimed invention;

FIGS. 9A-9B are front and back perspective views of the interchangeable pet harness dress with open neck ends and open torso ends in accordance with an exemplary embodiment of the claimed invention;

FIGS. 10A-10B are front and back perspective views of the pet harness and skirt (bottom part) of the interchangeable pet harness dress in an unattached state in accordance with an exemplary embodiment of the claimed invention;

FIG. 10C is an exploded view of the part connector of the pet harness and the part connector of the bottom part (skirt) in accordance with an exemplary embodiment of the claimed invention;

FIG. 11 is a cut-out view of various layers of the material of the pet harness apparel in accordance with exemplary embodiment of the claimed invention;

FIGS. 12A-12C are front and back perspective views of a turtleneck collar top part in accordance with an exemplary embodiment of the claimed invention;

FIGS. 13A-13B are front and back perspective views of the interchangeable collared pet harness in accordance with an exemplary embodiment of claimed invention;

FIG. 14 is a schematic view of the interchangeable collared pet harness in accordance with an exemplary embodiment of the claimed invention fitted on a pet;

FIGS. 15A-15B are front and back perspective views of the interchangeable collared pet vest harness in accordance with an exemplary embodiment of the claimed invention;

FIG. 16 is a schematic view of the interchangeable collared pet vest harness in accordance with an exemplary embodiment of the claimed invention fitted on a pet; and

FIGS. 17A-17B are front and back perspective views of the interchangeable collared pet harness jumper in accordance with an exemplary embodiment of the claimed invention.

### DETAILED DESCRIPTION OF THE EMBODIMENTS

The pet harness is generally favored by the pet owner over the collar fitted a pet's neck because it is easier to control the pet with the harness and it is harder to remove the harness for the pet. The harness enables the pet owner to concurrently pull the neck and trunk of the pet by pulling on the leash connected to the harness.

Pet owners desire to fashionably dress their pets have led to the evolution of leashes and simple harness into fashionable pet outfits and gears. However, it is difficult to change the look and style of the pet harness apparel without completely removing and replacing the currently worn pet harness apparel with a different pet harness apparel. Additionally, there is no option of mix and matching the tops and bottoms of the pet harness apparel.

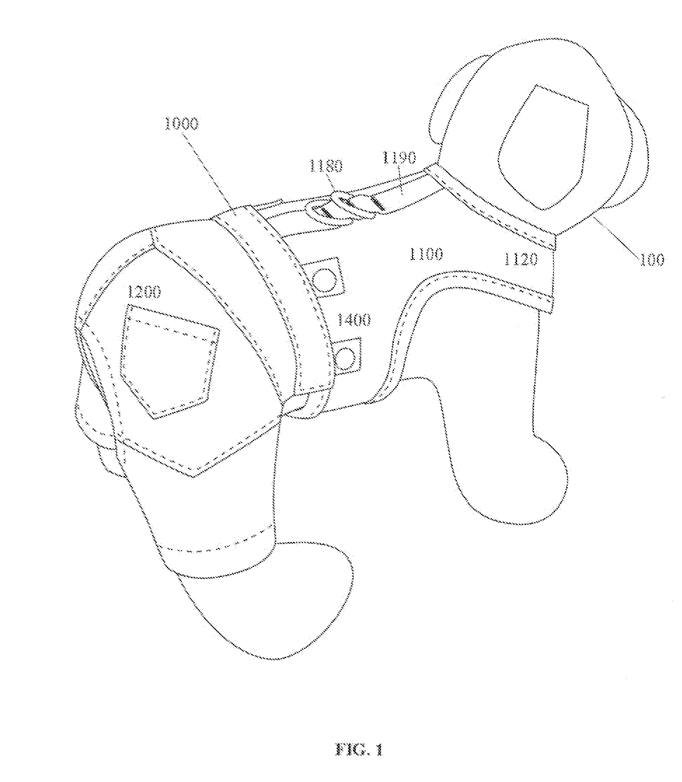

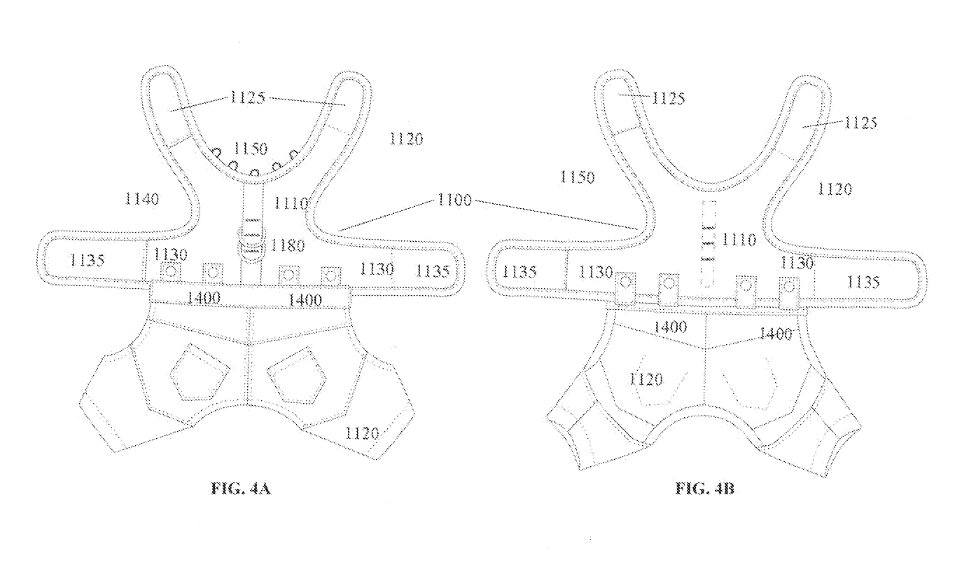

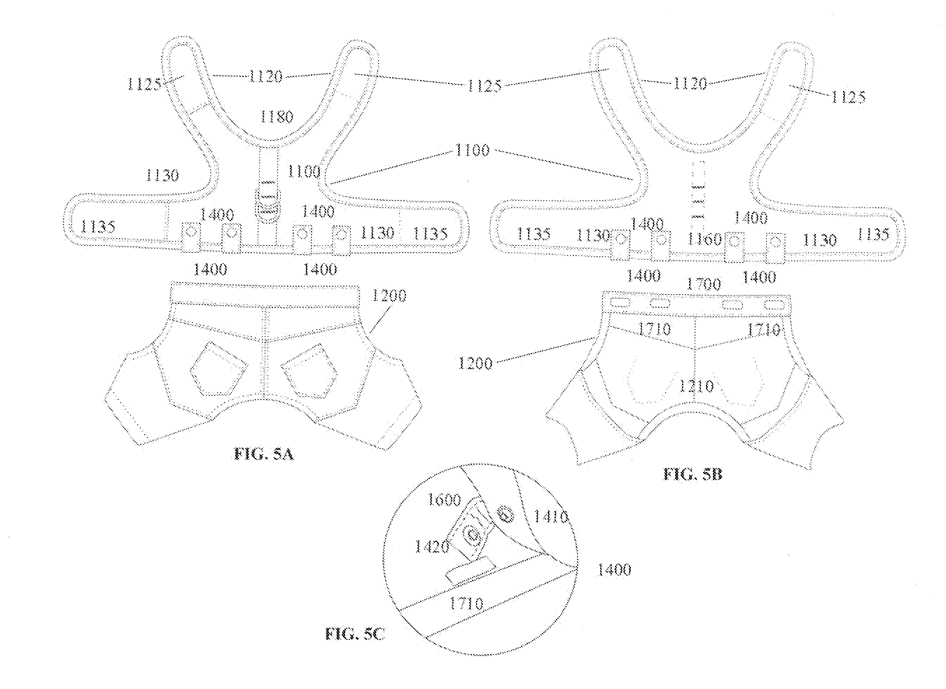

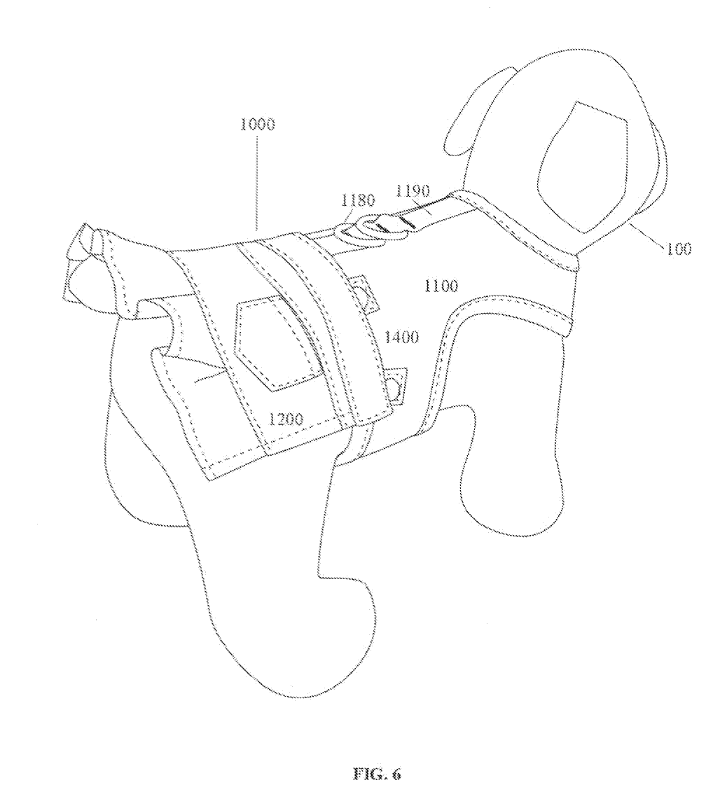

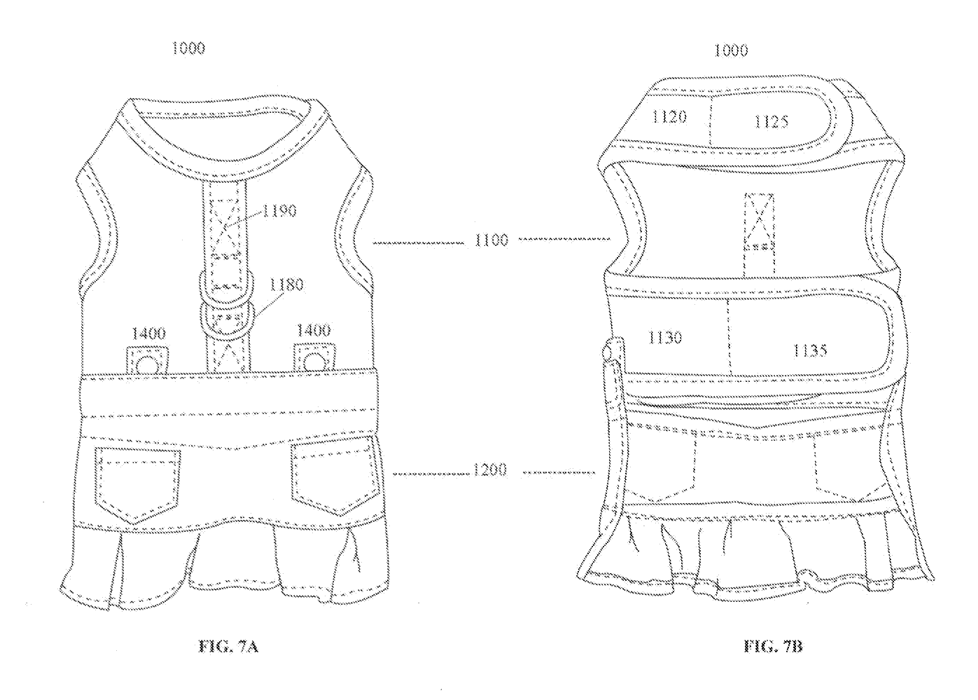

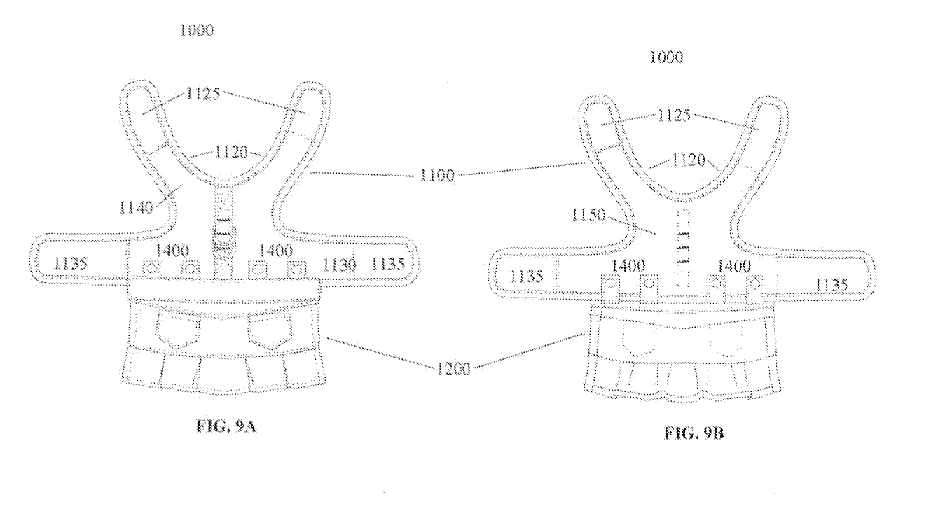

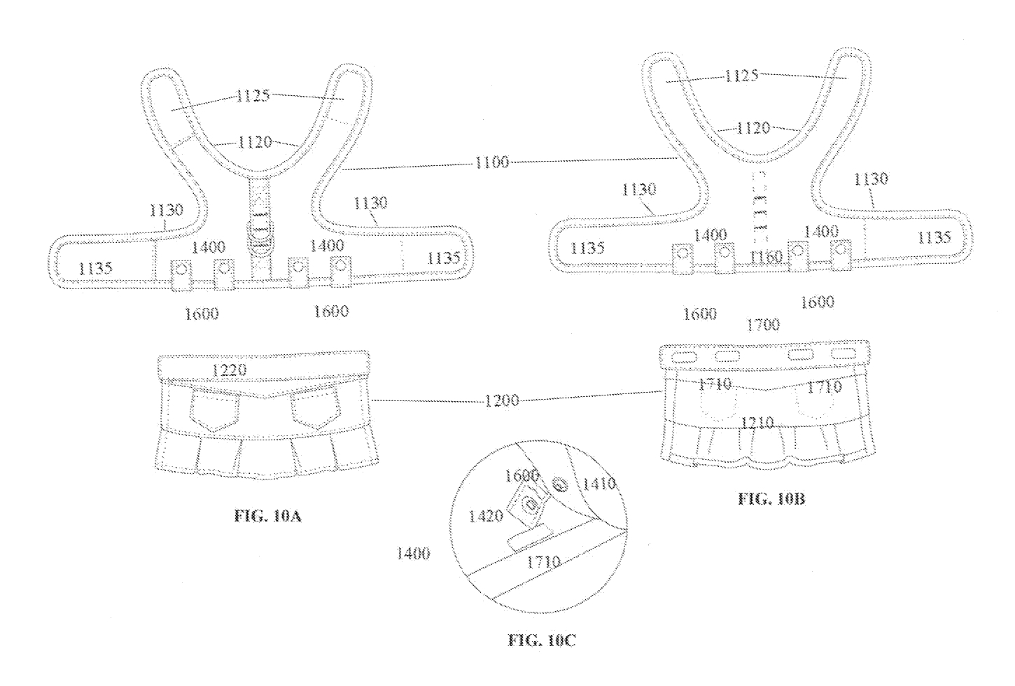

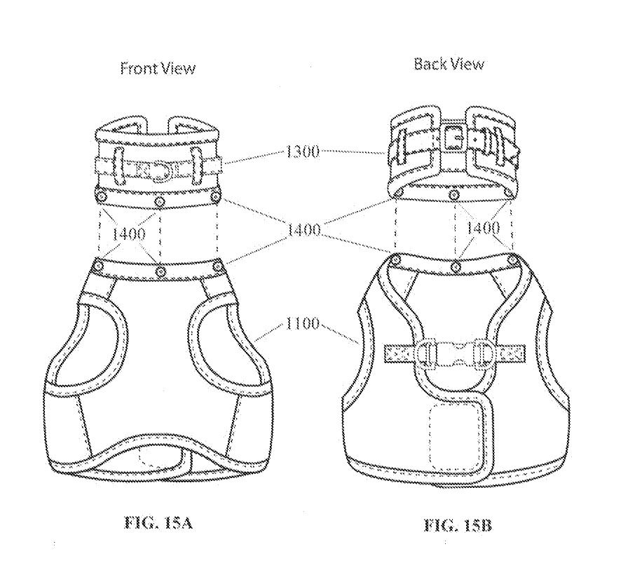

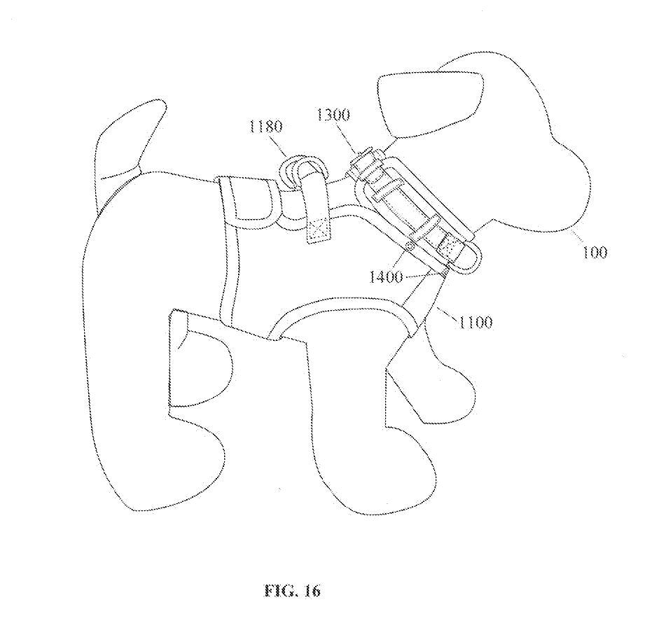

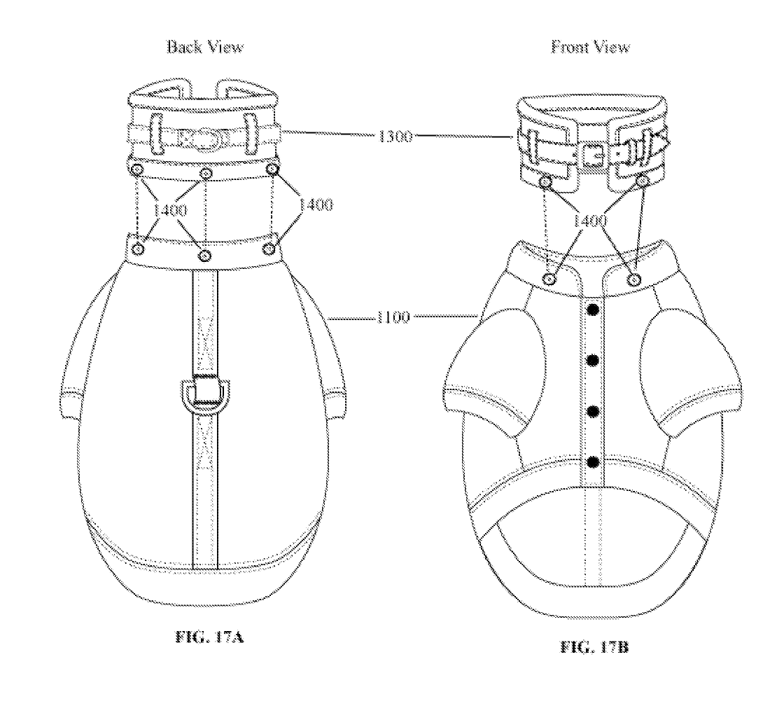

Turning now to FIGS. 1-10 and 12-17, there are illustrated interchangeable pet harness apparel 1000 in accordance with an exemplary embodiment of the claimed invention, which comprises a pet harness 1100 with a bottom part 1200 and/or a top part 1300. As exemplary shown in FIGS. 15-16, the pet harness 1100 can be a vest and as exemplary shown in FIGS. 17A-17B, the pet harness 1100 can be a jumper. Further, as exemplary shown in FIGS. 1-10 and 13-14, the pet harness 1100 can be shaped as a stylized letter K with a center portion 1110 to cover the back and chest area of the pet 100, two neck ends 1120 and two torso ends 1130. The two neck ends 1120 of the pet harness 1100 wrap around the neck of the pet 200, as exemplary shown in FIGS. 1 and 5. The two torso ends 1120 of the pet harness 1100 wrap around the torso of the pet 200, as exemplary shown in FIGS. 1 and 5.

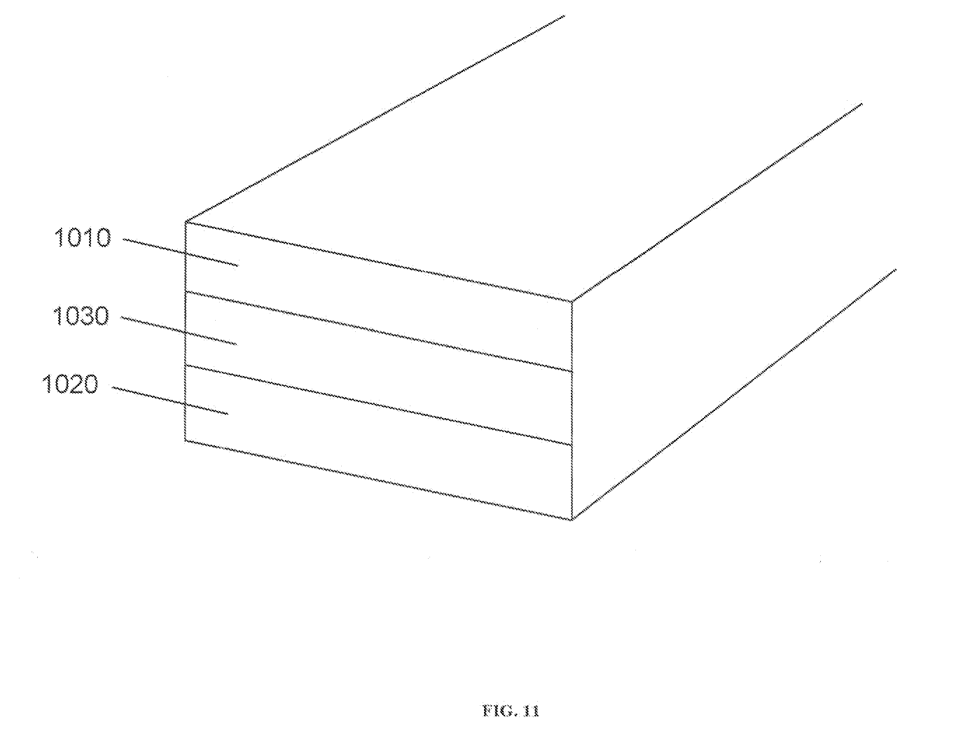

In accordance with an exemplary embodiment of the claimed invention, the pet harness apparel 1000 is made of sturdy material having sufficient elasticity to provide comfort and stretchability to enable the pet owners to keep their pets in control (especially for pets that tend to pull) while the pet harness apparel 1000 maintains or retains its original form. That is, the elastic property of the material retains original form of the pet harness harness 1000 even it is being pulled by the pet. In accordance with an aspect of the claimed invention, the pet harness apparel 1000 is made of a mesh-like material to provide for air-flow circulation to keep the pet 100 cool during hot weather. For example, the mesh-like material can be made of 100% polyester that is soft to the touch, lightweight, breathable and comfortable. Preferably, the pet harness apparel 1000 is constructed of multi-layers of material. As exemplary shown in FIG. 11, the pet harness apparel 1000 is constructed of three layers of material: an outer layer 1010, an inner layer 1020, and an internal layer or internal soft sponge-like cushion 1030 between the outer layer 1010 and inner layer 1020.

In accordance with an exemplary embodiment of the claimed invention, the internal layer 1030 can be infused with various fragrances, such as relaxing aromas, therapeutic aromas, colognes, perfumes, flea protection agents and the like. Preferably, the internal layer 1030 is bonded to the outer layer 1010 on one side and the internal layer 1020 on the other to prevent any shifting of the internal layer 1030.

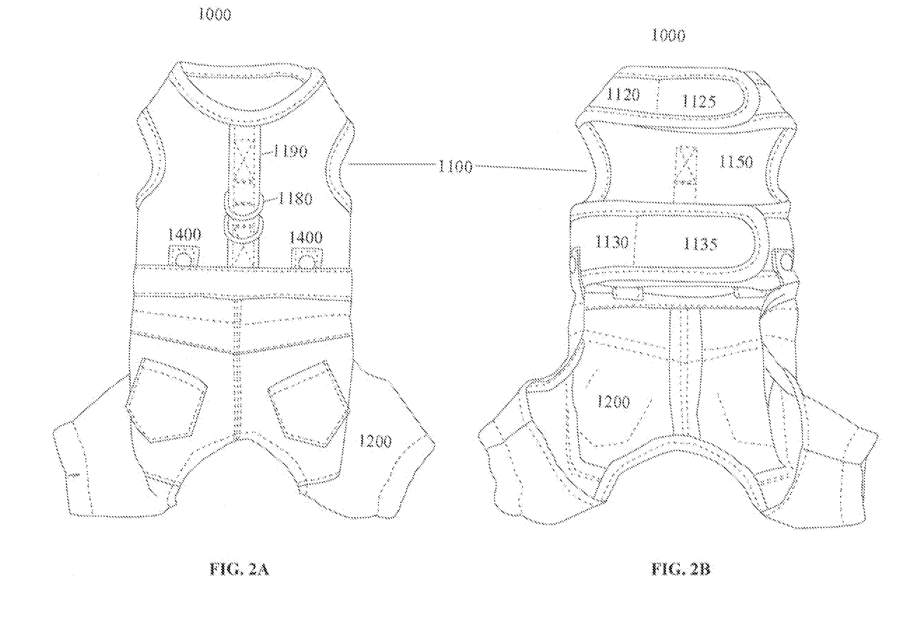

In accordance with an exemplary embodiment of the claimed invention, as exemplary shown in FIGS. 2B, 4A-4B, 5A-5B, 7A-7B, 9A-9B, 10A-10B, the pet harness 1100 of the pet harness apparel 1000 comprises two neck connectors 1125 to removably connect the two neck ends 1120 to each other. In accordance with an exemplary aspect of the claimed invention, each neck connector 1125 is a Velcro® strap 1125 (preferably a Velcro® hook and loop strap 1125) with one end of each Velcro strap 1125 fixedly attached to the respective neck end 1120. Preferably, each Velcro strap 1125 is stitched to the respective neck end 1120 of the harness 1000 to connect two neck ends 1120 to each other. The Velcro hook and loop strap 1125 is a fabric fastener comprised of a soft fuzzy (loop) side and a rougher (hook) side. Similarly, the top part 1100 of the pet harness apparel 1000 comprises two torso connectors 1135 to removable connect the two torso ends 1130 to each other. In accordance with an exemplary aspect of the claimed invention, each torso connector 1135 is a Velcro® strap 1135, preferably a Velcro® hook and loop strap 1135.

In accordance with an exemplary embodiment of the claimed invention, the pet harness 1100 of the pet harness apparel 1000 can be used by itself as a pet harness or in conjunction with the bottom part 1200 to form a pet harness outfit, e.g., a jumpsuit, a dress, a top with pants or a top with a skirt. The bottom part 1200 of the pet harness apparel 1000 is removably attachable to the pet harness 1100 to form a pet outfit or pet harness apparel 1000.

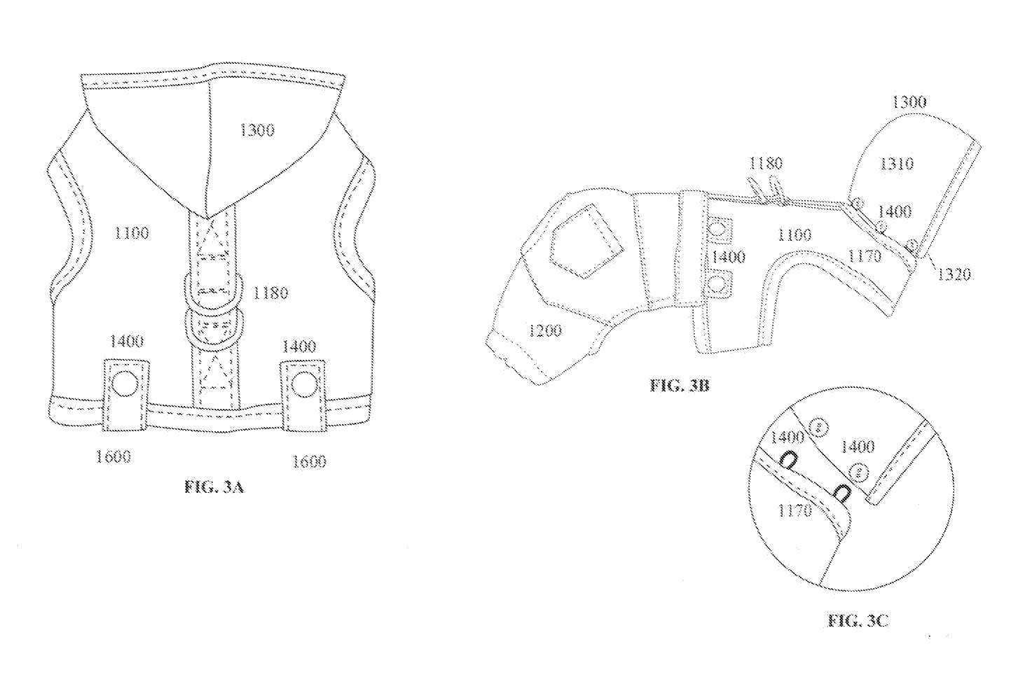

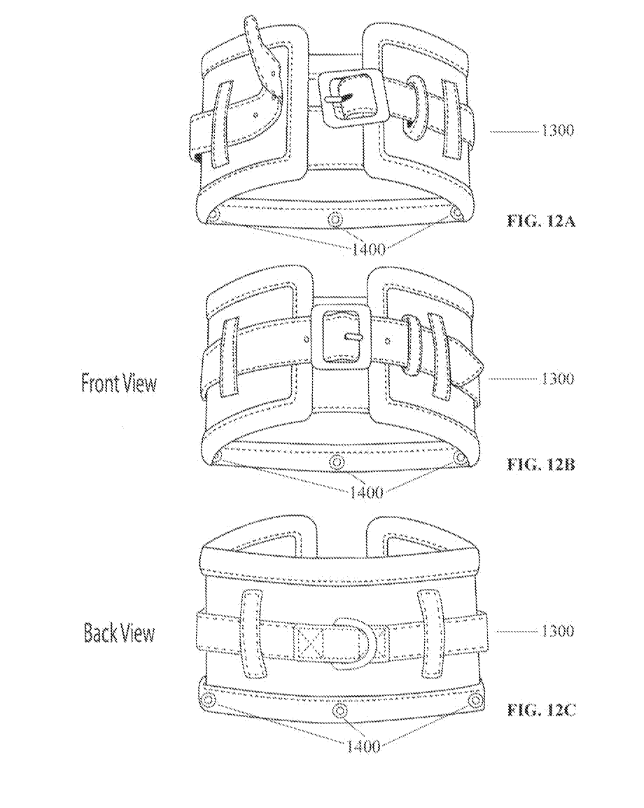

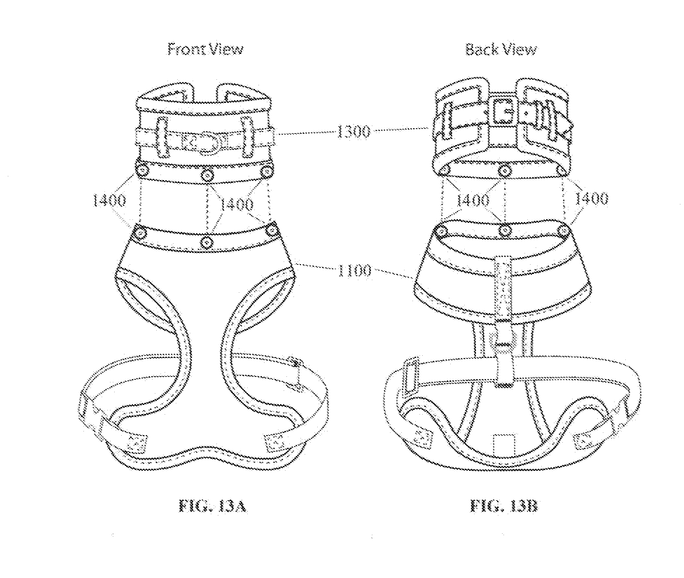

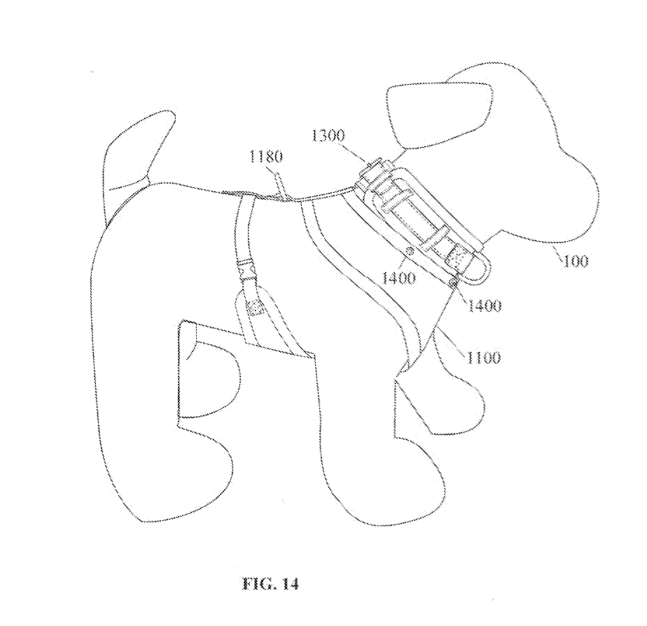

In accordance with an exemplary embodiment of the claimed invention, as exemplary shown in FIGS. 3A-3B, 8A-8B, 13-17, the pet harness 1100 of the pet harness apparel 1000 can be used in conjunction with a top part 1300 to form a collared outfit, a hooded outfit or a pet outfit with a cap, e.g., a hooded coat, a hooded jacket or a hooded top. The top part 1300 is removably attachable to the pet harness 1100 of the pet harness apparel 1000. As exemplary shown in FIGS. 12-17 The top part 1300 can be a turtleneck collar 1300 and can be connected to the pet harness 1100 by fasteners, Velcro® strips, buttons, snaps, fasteners, connectors, zippers, hooks and like (collectively referred to herein as part connectors 1400. The turtleneck collar 1300 can be connected to the pet harness 1100 to form a collared pet harness 1000, as exemplary shown in FIGS. 13A-14, or to form a collared pet harness vest 1000, as exemplary shown in FIGS. 15A-16, or to form a collared pet harness jumper 1000, as exemplary shown in FIG. 17.

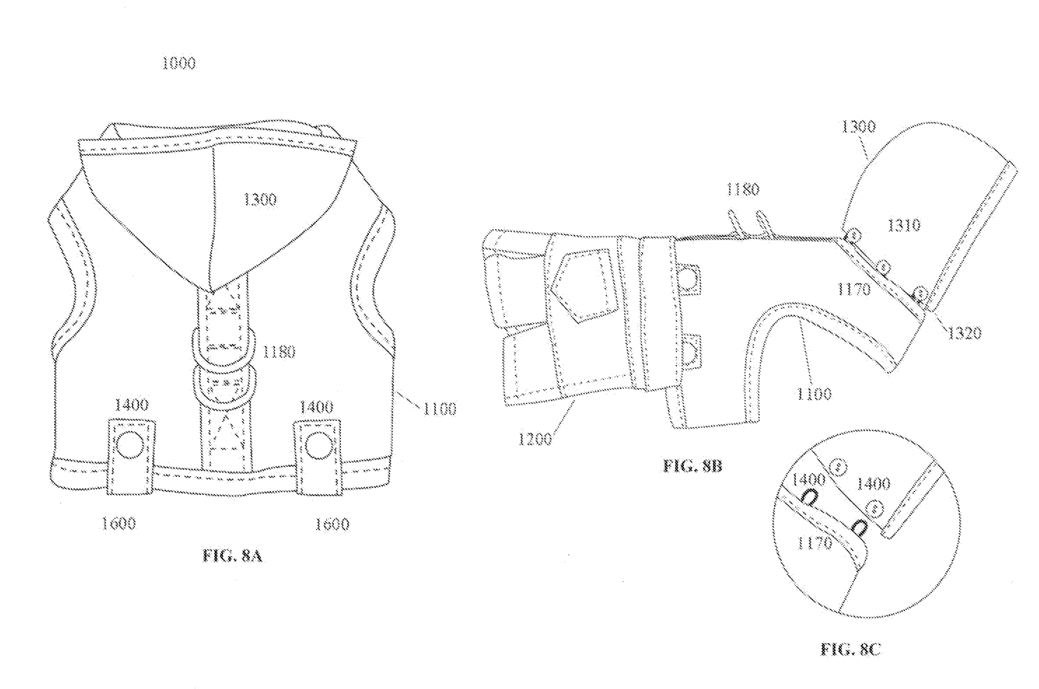

In accordance with an exemplary embodiment of the claimed invention, as exemplary shown in FIGS. 3A-3B, 8A-8B, the pet harness 1100 of the pet harness apparel 1000 can be used in conjunction with both the bottom part 1200 and the top part 1300 to provide, for example, a hooded jumpsuit.

The pet harness 1100 can be connected to the bottom part 1200 and/or top part 1300 by part connectors 1400. In accordance with an exemplary embodiment of the claimed invention, as exemplary shown in FIGS. 1-10 and 12-17, each of the pet harness 1100, bottom and top parts 1200, 1300 of the pet harness apparel 1000 comprises a part connector 1400 to connect the top part 1300 to the pet harness 1100 and the bottom part 1200 to the pet harness 1100. In accordance with an aspect of the claimed invention, each part connector 1400 is a Velcro® strip 1400 (preferably a Velcro® hook and loop strip) with one end of each Velcro® strip 1400 fixedly attached to the respective pet harness 1100, bottom and top parts 1200, 1300 of the pet harness apparel 1000. Preferably, each Velcro® strip 1400 is stitched one end of each pet harness 1100, bottom and top parts 1200 and 1300 of the pet harness apparel 1000. In accordance with an exemplary embodiment of the claimed invention, the Velcro® strip 1400, e.g., the rougher (hook) side of the Velcro® strip 1400, is stitched to the outer side 1140 of the pet harness 1100, preferably at the bottom end 1160 of the pet harness 1100 of the pet harness apparel 1000. Another Velcro® strip 1400, e.g., the soft fuzzy (loop) side of the Velcro® strip, is stitched to the inner side of the 1210 of the bottom part 1200 of the pet harness apparel 1000, preferably at the top end 1220 of the bottom part 1200, which mates with the rougher (hook) side of the Velcro® strip 1400 on the outer side 1140 of the pet harness 1100 at the bottom end 1160 of the pet harness 1100 to securely attach the bottom part 1200 to the pet harness 1100.

In accordance with an exemplary embodiment of the claimed invention, the Velcro® strip 1400, e.g., the rougher (hook) side of the Velcro® strip 1400, is stitched to the outer side 1140 of the pet harness 1100, preferably at the top end 1170 of the pet harness 1100 of the pet harness apparel 1000. Another Velcro® strip 1400, e.g., the soft fuzzy (loop) side of the Velcro® strip, is stitched to the inner side of the of the top part 1300 of the pet harness apparel 1000, preferably at the bottom end 1320 of the top part 1300, which mates with the rougher (hook) side of the Velcro® strip 1400 on the outer side 1140 of the pet harness 1100 at the top end 1170 of the pet harness 1100 to securely attach the top part 1300 to the pet harness 1100.

In accordance with an exemplary embodiment of the claimed invention, as exemplary shown in FIGS. 1-10 and 12-17, the part connector 1400 of the pet harness 1100 comprises a plurality of strips 1600 attached to the inner side 1150 of the pet harness 1100, preferably at the bottom end 1160 of the pet harness 1100. The first end 1410 of the fastener 1400, e.g., a female end of the fastener 1400 is attached to the outer side 1140 at the bottom end 1160 of the pet harness 1100. An opposing or second end 1420 of the fastener 1400, e.g., a male end of the fastener 1400, is attached the other end of each strip 1600.

In accordance with an exemplary embodiment of the claimed invention, the part connector 1400 of the bottom part 1200 comprises an elastic band 1700 on the inner side 1210 of the bottom part 1200, preferably at the top end 1220 of the bottom part 1200 of the pet harness apparel 1000. The elastic band 1700 is covered such that only certain portions of the elastic band 1700 are visible or accessible. Preferably, the accessible portions 1710 of the elastic band 1700 correspond to the positions where the strips 1600 at the bottom end of the pet harness 1100 connect to the bottom part 1200 of the pet harness apparel 1000. In accordance with an exemplary embodiment of the claimed invention, each strip 1600 at the bottom end 1160 of the pet harness 1100 loops around the corresponding accessible portion 1710 of the elastic band 1700 on the bottom part 1200 of the pet harness apparel 1000. The second end 1420 of the fastener 1400 on each strip 1600 attached to the bottom end 1160 of the pet harness 1100 removably connects to the first end 1410 of the fastener 1400 at the bottom end 1160 of the top part 1100 to securely attach the bottom part 1200 to the pet harness 1100.

In accordance with an exemplary embodiment of the claimed invention, as exemplary shown in FIGS. 3A-3C and 8A-8C, the part connector 1400 of the pet harness 1100 comprises a plurality of elastic loops attached to the inner side 1150 at the top end 1170 of the pet harness 1100.

In accordance with an exemplary embodiment of the claimed invention, the part connector 1400 of the top part 1300 comprises a plurality buttons on the outer side 1310 of the top part 1300, preferably at the bottom end 1320 of the top part 1300 of the pet harness apparel 1000. Preferably, the position of the buttons 1400 at the bottom end 1320 of the top part 1300 correspond to the positions where the elastic loops 1400 at the top end 1170 of the pet harness 1100 to connect to the top part 1300 of the pet harness apparel 1000.

In accordance with an exemplary embodiment of the claimed invention, the part connectors 1400 at the top end 1170 and/or bottom end 1160 of the pet harness 1100 comprises a plurality of buttons, and the part connectors 1400 of the bottom part 1200 and the top part 1300 comprises a plurality of button holes to received the buttons on the top part 1100 to securely attach the top part 1300 and/or bottom part 1200 to the pet harness 1100.

In accordance with an exemplary embodiment of the claimed invention, the pet owner can mix and match tops, bottoms and headgear of the pet outfit with the interchangeable pet harness apparel 1000 of the claimed invention. The interchangeable pet harness dress 1000 of the claimed invention can be changed to interchangeable pet harness jumpsuit 1000 of the claimed invention without removing the pet harness 1100 or the entire interchangeable pet harness apparel 1000 from the pet 200. With the interchangeable pet harness apparel 1000 of the claimed invention, the pet owner can simply detach the skirt bottom part 1200 from the pet harness 1100 of the interchangeable pet harness dress 1000 and attach pants bottom part 1200 to the pet harness 1100 of the interchangeable pet harness apparel 1000 to convert the pet harness dress 1000 into a pet harness jumpsuit 1000 without removing the pet harness 1100, thereby advantageously enabling the pet owner to change the outfit while maintaining control of even active pet 200.

In accordance with an exemplary embodiment of the claimed invention, the pet owner can change the style of the pet harness jumpsuit 1000 or pet harness dress 1000 by changing the skirt bottom part 1200 (e.g., a solid colored skirt bottom part 1200) to a different skirt bottom part 1200 (e.g., a floral pattern skirt bottom part 1200) or the striped pants bottom part 1200 to a red colored pants bottom without removing the pet harness 1100 or the entire pet harness apparel 1000 from pet 200.

In accordance with an exemplary embodiment of the claimed invention, as shown in FIGS. 3A-3C, 8A-8C, the pet owner can attach the removable hood 1300 to the pet harness 1100 of the pet harness jumpsuit 1000 or pet harness dress 1000 to change the style to a hooded pet harness jumpsuit 1000 or a hooded pet harness dress 1000. Typically, with existing pet apparel, the pet owner would need to remove the jumpsuit entirely from her pet and replace it with the hooded jumpsuit to change the style of the pet outfit. This can be burdensome and take a long time with a pet harness for an active pet that does not stay still. With the interchangeable pet harness apparel 1000 of the claimed invention, this process of mixing and matching, and changing pet attire is greatly simplified. The pet owner can detach and replace the top part 1300 and/or the bottom part 1200 of the pet harness apparel 1000 while maintaining control of the pet 200 using the pet harness 1100 of the pet harness apparel 1000, which remains on the pet 200 and is not removed during the attire change.

In accordance with an exemplary embodiment of the claimed invention, the pet harness 1100 can be converted into a pet harness apparel 1000 by attaching a bottom part 1200 and/or a top part 1300 to the pet harness 2000. For example, pants bottom 1200 can be removably attached to the pet harness 1100 to provide a pet harness jumpsuit 1000. A hooded top part 1300 can be removably attached to the pet harness to convert the pet harness jumpsuit 1000 to a hooded pet harness jumpsuit. The pants bottom 1200 can be replaced with a skirt bottom 1200 to provide a hooded pet harness dress 1000. The skirt bottom 1300 can be removed from the hooded pet harness dress 1000 to provide a hooded pet harness top 1000. The pet owner can create multiple pet harness outfits 1000 from one pet harness 1100 by simply mixing and matching the bottom part 1200 and/or the top part 1300 with the pet harness 1100.

In accordance with an exemplary embodiment of the claimed invention, the bottom part 1200 of the interchangeable pet harness apparel 1000 can be, but not limited to, one of the following: pants, shorts, a skirt, panties, pet sanitary panties, a manner band and the like. The pet sanitary panties and the manner band are for “good manners,” for example, to prevent the pets 100 from peeing inside house or to discreetly cover their parts when they are in heat.

In accordance with an exemplary embodiment of the claimed invention, the top part 1300 of the interchangeable pet harness apparel 1000 can be, but not limited to, one of the following: a collar, a neck guard, a turtleneck collar, a clothing collar, e.g., a dress collar, a dress collar with a bow tie, a shirt color, a shirt collar with a neck tie, a blouse collar, a blouse collar with a bow tie, a shirt collar with a bow tie, a blouse collar with a ribbon, etc., and the like (collectively referred to herein as the “collar”), a hood, a cap, a hat and the like.

In accordance with an exemplary embodiment of the claimed invention, the interchangeable pet harness apparel can be, but not limited to, one of the following: a pet harness jumpsuit, a hooded pet harness jumpsuit, a pet harness dress, a hooded pet harness dress, pet harness short, hooded pet harness shorts, a pet manner harness, a hooded pet manner harness, a pet harness with panties, a hooded pet harness with panties, a pet harness with pet sanitary panties, a hooded pet harness with pet sanitary panties, a pet harness jumpsuit with a cap, a pet harness dress with a cap, pet harness shorts with a cap, a pet manner harness with a cap, a pet harness with a cap and panties, a pet harness with a cap and pet sanitary panties, a pet harness jumpsuit with a hat, a pet harness dress with a hat, pet harness shorts with a hat, a pet manner harness with a hat, a pet harness with a hat and panties, a pet harness with a hat and pet sanitary panties, a pet collared harness jumpsuit, a pet collared harness dress, pet collared harness shorts, a pet collared manner harness, a pet collared harness with panties, a pet collared harness with pet sanitary panties and the like.

In accordance with an exemplary embodiment of the claimed invention, as exemplary shown in FIGS. 1-10C, the top part 1100 of the pet harness apparel 1000 comprises one or more (preferably two) D-rings 1180, which can plastic, metal and the like, for attaching a leash (not shown). The D-rings 1180 are fixedly attached to a folded strap 1190 made of durable material, such as nylon. The D-rings 1180 are located between the folded strap 1190, which is fixedly attached to the center portion 1110 of the top part, as shown in FIGS. 1-10C. That is, the folded strap 1190 loops around the D-rings 1180, and the top and bottom portions of the folded strap 1190 near the D-rings 1180 are stitched together to keep the D-rings 1180 fixedly attached to the center portion 1110 of the top part 1100, thereby restraining the D-rings 1180 from any sliding movements along the folded strap 1190 but retaining pendular motion or movement.

The invention, having been described, it will be apparent to those skilled in the art that the same may be varied in many ways without departing from the spirit and scope of the invention. Any and all such modifications are intended to be included within the scope of the following claims.

We claim:

1. Interchangeable pet harness apparel, comprising:
a pet harness comprising at least one D-ring fixedly attached to the pet harness to attach a lease and a part connector at a bottom end of the pet harness; and
a plurality of interchangeable bottom parts of a pet apparel, each bottom part comprising a part connector to removably attach the respective bottom part to the pet harness such that the part connector of the respective bottom part mates with the part connector of the pet harness to attach the respective bottom part to the pet harness to form a pet harness outfit; and
wherein the part connectors of the pet harness and of the respective bottom part permit the pet harness outfit to be changed without removing the entire pet harness outfit and without removing the pet harness worn by a pet during an attire change by detaching the respective bottom part from the pet harness and replacing it with another bottom part.

2. The interchangeable pet harness apparel of claim 1, wherein the bottom part is pants and the part connector of the bottom part mates with the part connector at the bottom end of the pet harness to form a pet harness jumpsuit.

3. The interchangeable pet harness apparel of claim 2, wherein the bottom part of the pet harness jumpsuit is interchangeable with another bottom part by decoupling the part connector of the pants from the part connector at the bottom end of the pet harness and mating the part connector of a skirt, shorts, panties, pet sanitary panties, a manner band or another pants to the part connector at the bottom end of the pet harness to convert the pet harness jumpsuit to a different pet harness outfit or to change color or style of the pet harness jumpsuit.

4. The interchangeable pet harness apparel of claim 1, wherein the bottom part is a skirt and the part connector of the bottom part mates with the part connector at the bottom end of the pet harness to form a pet harness dress.

5. The interchangeable pet harness apparel of claim 4, wherein the bottom part of the pet harness dress is interchangeable with another bottom part by decoupling the part connector of the skirt from the part connector at the bottom end of the pet harness and mating the part connector of pants, shorts, panties, pet sanitary panties, a manner band or another skirt to the part connector at the bottom end of the pet harness to convert the pet harness dress to a different pet harness outfit or to change color or style of the pet harness dress.

6. The interchangeable pet harness apparel of claim 1, further comprising a plurality of interchangeable top parts of the pet apparel, each top part comprising a part connector to removably attach the respective top part to the pet harness such that the part connector of the respective top part mates with the part connector at a top end of the pet harness to attach the respective top part to the pet harness; and wherein the part connectors at the top end of the pet harness and of the respective top part permit the respective top part to be detached from the pet harness and replaced with another top part to change the pet harness outfit without removing the entire pet harness outfit or the pet harness worn by the pet during an attire change.

7. The interchangeable pet harness apparel of claim 6, wherein the top part is a hood and the part connector of the top part mates with the part connector at the top end of the pet harness to form a hooded pet harness outfit.

8. The interchangeable pet harness apparel of claim 7, wherein the top part of the hooded pet harness outfit is interchangeable with another top part by decoupling the part connector of the hood from the part connector at the top end of the pet harness and mating the part connector of a collar, a cap, a hat or another hood to the part connector at the top end of the pet harness to convert the hooded pet harness outfit to a collared pet harness outfit, a pet harness outfit with a cap a pet harness outfit with a hat, or to change color or style of the hooded pet harness outfit.

9. The interchangeable pet harness apparel of claim 6, wherein the top part is a collar and the part connector of the top part mates with the part connector at the top end of the pet harness to form a collared pet harness outfit.

10. The interchangeable pet harness apparel of claim 9, wherein the top part of the collared pet harness outfit is interchangeable with another top part by decoupling the part connector of the collar from the part connector at the top end of the pet harness and mating the part connector of a hood, a cap, a hat or another collar to the part connector at the top end of the pet harness to convert the collared pet harness outfit to a hooded pet harness outfit, a pet harness outfit with a cap, a pet harness outfit with a hat or to change color or style of the collared pet harness outfit.

11. The interchangeable pet harness apparel of claim 1, wherein the pet harness and the bottom parts are made of sturdy, elastic mesh-like polyester material to provide lightweight, breathable and comfortable pet harness apparel.

12. The interchangeable pet harness apparel of claim 1, wherein the pet harness and the bottom parts are made of sturdy material comprising an outer layer, an inner layer and an internal layer between the outer and inner layers; and wherein the internal layer is infused with one or more of the following fragrances: relaxing aroma, therapeutic aroma, cologne, perfume and flea protection agent.

13. The interchangeable pet harness apparel of claim 1, wherein the part connector at the bottom end of the pet harness and the part connector of the respective bottom part is a pair of mated fastener, snap, button and loop, button and button hole, zipper or a hook and loop strip.

14. The interchangeable pet harness apparel of claim 1, wherein the part connector of the pet harness comprises a plurality of thin strips, one end of each strip is attached to the bottom end of the pet harness by a first end of mated fastener and a second end of the mated fastener is attached to other end of each strip; wherein the part connector of the respective bottom part comprises an elastic band at the top end of the respective bottom part with predetermined portions of the elastic band being accessible; wherein each strip at the top end of the pet harness loops around a corresponding accessible portion of the elastic band on the respective bottom part and the second end of the mated fastener on each strip removably connects to the first end of the mated fastener on the each corresponding strip to securely attach the respective bottom part to the pet harness to form the pet harness outfit.

15. The interchangeable pet harness apparel of claim 6, wherein the part connector at the top end of the pet harness and the part connector of the respective top part is a pair of mated fastener, snap, button and loop, button and button hole, zipper or a hook and loop strip.

16. Interchangeable pet harness apparel, comprising:
a pet harness comprising at least one D-ring fixedly attached to the pet harness to attach a lease and a part connector at a top end of the pet harness; and
a plurality of interchangeable top parts of a pet apparel, each top part comprising a part connector to removably attach the respective top part to the pet harness such that the part connector of the respective top part mates with the part connector of the pet harness to attach the respective top part to the pet harness to form a pet harness outfit; and
wherein the part connectors of the pet harness and of the respective top part permit the respective top part to be detached from the pet harness and replaced with another top part to change the pet harness outfit without removing the entire pet harness outfit or the pet harness worn by a pet during an attire change.

17. The interchangeable pet harness apparel of claim 16, wherein the top part is a hood, a hat, a cap or a collar to respectively form a hooded pet harness outfit, a pet harness outfit with a hat, a pet harness outfit with a cap or a collared pet harness outfit.

18. The interchangeable pet harness apparel of claim 16, further comprising a plurality of interchangeable bottom parts of the pet apparel, each bottom part comprising a part connector to removably attach the respective bottom part to the pet harness such that the part connector of the respective bottom part mates with the part connector at a bottom end of the pet harness to attach the respective bottom part to the pet harness; and wherein the part connectors at the bottom end of the pet harness and of the respective bottom part permit the respective bottom part to be detached from the pet harness and replaced with another bottom part to change the pet harness outfit without removing the entire pet harness outfit or the pet harness worn by the pet during an attire change.

19. The interchangeable pet harness apparel of claim 18, wherein the bottom part is pants, shorts, panties, pet sanitary panties, a manner band or a skirt to form a hooded pet harness outfit, a pet harness outfit with a cap, a pet harness outfit with a hat or a collared pet harness outfit.

20. The interchangeable pet harness apparel of claim 18, wherein the part connector at the top end of the pet harness and the part connector of the respective top part is a pair of mated fastener, snap, button and loop, button and button hole, zipper or a hook and loop strip; and wherein the part connector at the bottom end of the pet harness and the part connector of the respective bottom part is a pair of mated fastener, snap, button and loop, button and button hole, zipper or a hook and loop strip.
